(19) United States
(12) Patent Application Publication
(10) Pub. No.: US 2025/0338850 A1
(43) Pub. Date: Nov. 6, 2025

(54) COMPOSITION AND METHOD FOR CONTROLLING WEEDS IN TURFGRASS

(71) Applicant: SYNGENTA CROP PROTECTION AG, Basel (CH)

(72) Inventors: John Robert JAMES, Greensboro, NC (US); David PEARSAUL, Vero Beach, FL (US); Lane TREDWAY, Greensboro, NC (US)

(73) Assignee: SYNGENTA CROP PROTECTION AG, Basel (CH)

(21) Appl. No.: 18/866,439

(22) PCT Filed: May 16, 2023
(86) PCT No.: PCT/EP2023/063175

§ 371 Date: Nov. 15, 2024

(30) Foreign Application Priority Data
May 16, 2022 (EP) 22173597.0

(51) Int. Cl. A01N 47/36; A01N 25/32; A01P 13/02

(52) U.S. Cl. CPC A01N 47/36; A01N 25/32; A01P 13/02

(57) ABSTRACT

The present invention relates to a method of controlling weeds in susceptible turfgrass without causing significant injury to the turfgrass, comprising applying to the turfgrass a herbicidally effective amount of trifloxysulfuron, or a salt or hydrate thereof and an effective amount of metcamifen as safener.

The present invention relates to a composition and method for controlling weeds in turf without causing significant injury to the turfgrass. In particular, the invention relates to a composition and method for controlling weeds in certain susceptible warm season turfgrass without causing significant injury to the turfgrass using a composition comprising a herbicidally effective amount of trifloxysulfuron and a metcamifen safener.

The need for removal of unwanted plants and other undesirable vegetation such as noxious weeds and invasive plants is a constantly recurring problem in agriculture as well as in landscaped and industrial areas. For example, selectively removing problematic weeds and invasive species from golf courses (greens, fairways, tees, and roughs), sports fields, industrial turfgrass and residential turfgrass is essential for maintaining high quality, healthy turf. Weeds can decrease the quality of turf due to the contrast in colour and texture between the turfgrass plants and the weeds. In addition, weeds compete with the turfgrass plants for available water and nutrients, usually resulting in thinning of desirable turfgrass cover. Accordingly, there exists a need for novel methods to control weeds in turfgrass and to provide high quality, healthy turf.

Trifloxysulfuron (N-[[(4,6-dimethoxy-2-pyrimidinyl)amino]carbonyl]-3-(2,2,2-trifluoroethoxy)-2-pyridinesulfonamide) (CAS RN: 145099-21-4; EP540697B1) is a acetolactate synthase (ALS) inhibitorALS herbicide useful for controlling certain broadleaf, sedge and grassy weeds in turfgrass. However, trifloxysulfuron is phytotoxic to certain susceptible turfgrasses. Trifloxysulfuron phytotoxicity is particularly severe when it is applied to control weeds in certain warm season turfgrasses. 290332-10-4

Metcamifen (2-Methoxy-N-[[4-[[(methylamino) carbonyl]amino]phenyl]sulfonyl]benzamide) (CAS RN: 129531-12-0; U.S. Pat. No. 5,215,570) is a safener compound useful for protecting cultivated plants against the damaging effect of various selective herbicides. Certain crystalline polymorph forms of the safener metcamifen including Form 1, Form 2 and Form 3 also are known (WO2013/117691).

Hephner et al. “Sequential Postemergence Applications for the Control of Khakiweed in Bermudagrass Turf”, HortScience horts, 47 (3), 434-436 (2012) describes the treatment of bermudagrass to control Khakiweed with trifloxysulfuron or metsulfuron, in the presence or not of carfentrazone.

There remains a need for improved trifloxysulfuron weed control compositions and methods in certain ALS susceptible turfgrass which reduces the phytotoxicity of trifloxysulfuron to such turfgrass.

Surprisingly, it has now been found that the phytotoxic effects of trifloxysulfuron can be further reduced when applied in combination with metcamifen for the selective control of unwanted weeds in the presence of susceptible or sensitive turfgrass, without loss of herbicidal efficacy. In particular, it has been found that the phytotoxic effects of trifloxysulfuron, or a salt or hydrate thereof, can be further reduced when it is applied in combination with metcamifen to selectively control weeds in certain susceptible warm season turfgrass (esp. St. Augustinegrass and Kikuyugrass) and without loss of herbicidal efficacy against such weeds.

According to the present invention, there is provided a method of controlling weeds in susceptible turfgrass without causing significant injury to the turfgrass, comprising applying to the turfgrass a herbicidally effective amount of trifloxysulfuron, or a salt or hydrate thereof and an effective amount of metcamifen as safener.

In particular, the present invention comprises selectively controlling unwanted weeds in the presence of a susceptible warm season (C4) turfgrass at a turfgrass locus without causing significant injury to the turfgrass, comprising applying to the turfgrass locus a herbicidally effective amount of trifloxysulfuron, or a salt or hydrate thereof and an effective amount of metcamifen as safener.

More specifically, the present invention provides a method of selectively controlling unwanted weeds in the presence of an ALS susceptible warm season (C4) turfgrass at a turfgrass locus without causing significant injury to the turfgrass and, preferably, without antagonizing herbicidal efficacy, comprising applying to the turfgrass locus a herbicidally effective amount of trifloxysulfuron, or a salt or hydrate thereof and an effective amount of metcamifen as safener.

The method of present invention is particularly suitable for selectively controlling unwanted weeds in the presence of a warm season (C4) turfgrass selected from St. Augustinegrass and Kikuyugrass at a turfgrass locus without causing significant injury to the St. Augustinegrass or Kikuyugrass and, preferably, without antagonizing herbicidal efficacy, comprising applying to the turfgrass locus a composition comprising a herbicidally effective amount of trifloxysulfuron, or a salt or hydrate thereof and an effective amount of metcamifen as safener.

The present invention also provides a safened herbicidal composition for use in turfgrass susceptible to injury by an ALS herbicide, including a turfgrass selected from St. Augustinegrass and Kikuyugrass, comprising: a) a herbicidally effective amount of trifloxysulfuron, or a salt or hydrate thereof; and b) an effective safening amount of metcamifen, wherein the safened herbicidal composition is capable of safening the trifloxysulfuron, or a salt or hydrate thereof, or a salt thereof, to the turfgrass.

The present invention further provides a method for reducing phytotoxicity to warm season (C4) turfgrass such as St. Augustinegrass or Kikuyugrass due to application of an ALS herbicidal compound such as trifloxysulfuron, or a salt or hydrate thereof alone or in admixture with one or more co-herbicidal compounds which comprises applying a herbicidally effective amount of an herbicide selected from an ACCase herbicide, a pyridine herbicide and, optionally, trifloxysulfuron; and an effective amount of metcamifen as safener to the turfgrass locus.

The present invention further provides a method for conversion of an established turfgrass selected from bermudagrass, seashore paspalum, creeping bentgrass, tall fescue, and kentucky bluegrass at a turfgrass locus comprising::spreading sprigs of a turfgrass selected from zoysiagrass, St. augustinegrass, and kikuyugrass at 100 to 200 cubic meters per hectare on top of established turfgrass at the turfgrass locus; and applying a herbicidally effective amount of an herbicide selected from an ACCase herbicide, a pyridine herbicide and, optionally, trifloxysulfuron; and an effective amount of metcamifen as safener to the turfgrass locus.

Embodiments according to the method of the invention are provided as set out below.

In one embodiment, trifloxysulfuron (N-[[(4,6-dimethoxy-2-pyrimidinyl)amino]carbonyl]-3-(2,2,2-trifluoroethoxy)-2-pyridinesulfonamide) is applied to the turf grass.

In another embodiment, trifloxysulfuron can be applied or formulated as a salt such as a sodium salt (CAS RN: 199119-58-9), as a hydrate or both (For example, trifloxysulfuron-Na B-hydrate (CAS RN: 290332-10-4). Unless otherwise specifically stated, reference to trifloxysulfuron herein is understood to mean trifloxysulfuron, a salt or a hydrate thereof.

In one embodiment, a herbicidally effective amount of trifloxysulfuron is applied to the turfgrass at a rate of from 5 to 56 g ai/ha; more specifically at a rate of from 18 to 28 g ai/ha.

In one embodiment, metcamifen as (2-Methoxy-N-[[4-[[(methylamino) carbonyl]amino]phenyl]sulfonyl]benzamide) is used as a safener in the composition or the method of the present invention.

In another embodiment, Metcamifen can be applied or formulated as a crystalline polymorph designated Form 1 as described in WO2013/117691, which is characterised, for example, by a powder X-ray diffraction pattern expressed in terms of 2θ angles, wherein the powder X-ray diffraction pattern comprises at least three, at least four, at least five, at least six, at least 7 or all 20 angle values (in degrees) selected from the group comprising 7.4±0.2, 9.3±0.2, 11.7±0.2, 12.0±0.2, 14.3±0.2, 15.1±0.2, 17.4±0.2 and 19.0±0.2. Form 1 has a melting point of 198° C.±5° C. This melting point is obtained using Differential Scanning calorimetry (DSC) with a heating rate of 10° C./minute.

In another embodiment, Metcamifen can be applied or formulated as a crystalline polymorph designated Form 2 as described in WO2013/117691, which is characterised by a powder X-ray diffraction pattern expressed in terms of 2θ angles, wherein the powder X-ray diffraction pattern comprises at least one 20 angle value at 9.0±0.2; and one 20 angle value at 21.7±0.2; and at least three, at least four, at least five, at least six or all 20 angle values selected from the group comprising 7.7±0.2, 11.9±0.2, 13.4±0.2, 15.0±0.2, 15.6±0.2, 16.1±0.2 and 18.0±0.2. Form 2 has a melting point of 216° C.±5° C. This melting point is obtained using Differential Scanning calorimetry (DSC) with a heating rate of 10° C./minute.

In another embodiment, Metcamifen can be applied or formulated as a crystalline polymorph designated Form 3 as described in WO2013/117691, which is characterised by a powder X-ray diffraction pattern expressed in terms of 2θ angles, wherein the powder X-ray diffraction pattern comprises one 20 angle value at 16.9±0.2; and one 20 angle value at 18.9±0.2; and at least three, at least four, at least five, at least six, at least seven, at least eight, at least nine, at least ten or all 20 angle values selected from the group comprising 7.5±0.2, 12.3±0.2, 13.4±0.2, 14.4±0.2, 14.9±0.2, 15.8±0.2, 18.3±0.2, 20.9±0.2, 21.9±0.2, 22.6±0.2 and 23.8±0.2. Form 3 has a melting point of 202° C.±5° C. This melting point is obtained using Differential Scanning calorimetry (DSC) with a heating rate of 10° C./minute.

Unless otherwise specifically stated, reference to Metcamifen herein is understood to mean Metcamifen as (2-Methoxy-N-[[4-[[(methylamino)carbonyl]amino]phenyl]sulfonyl]benzamide) or a polymorph (Form 1, Form 2, or Form 3) thereof.

In one embodiment, an effective amount of metcamifen as safener is a safening or antidotally effective amount. Preferably, a safening or antidotally effective amount of metcamifen that is applied to the turfgrass at a rate of from 5 to 300 g ai/ha; more specifically at a rate of from 25 to 150 g ai/ha.

In one embodiment, in the method of the invention, the herbicidally effective amount of trifloxysulfuron, or a salt or hydrate thereof and the safening effective amount of metcamifen are applied to the turf locus simultaneously or sequentially. In a preferred embodiment, the trifloxysulfuron, or a salt or hydrate thereof and metcamifen are applied to the turf locus simultaneously; preferably, with a safened herbicidal composition of the invention.

Preferably, in the method of the invention, the trifloxysulfuron, or a salt or hydrate thereof and the metcamifen are applied simultaneously or sequentially to the turf locus by a post-emergence foliar treatment; more preferably a post-emergence aqueous spray foliar treatment. More preferably, the trifloxysulfuron, or a salt or hydrate thereof and the metcamifen are applied simultaneously to the turf locus by a post-emergence foliar treatment with an aqueous spray composition.

In one embodiment, the trifloxysulfuron, or a salt or hydrate thereof and the metcamifen are applied to the turf locus in an aqueous spray composition. In another embodiment, the aqueous spray volume applied to the turf locus is from 100 to 300 l/ha; Preferably, the water volume of the aqueous spray composition applied to the turf locus is from 150 to 200 l/ha.

In one embodiment, 1 to 3 post sequential foliar applications of the trifloxysulfuron, or a salt or hydrate thereof and the metcamifen are made to the turf locus on a 7 to 42-day spray schedule or interval: preferably, on 14-day to 21-day intervals.

In one embodiment, in the method of the invention a herbicidally effective amount of trifloxysulfuron, or a salt or hydrate thereof and a safening amount of metcamifen (i.e., an effective amount of metcamifen as safener) are applied to a turfgrass locus comprising the unwanted broadleaf, sedge or grassy weeds to be controlled and the desired ALS (trifloxysulfuron) susceptible warm season (C4) turfgrass species (such as St. Augustinegrass and Kikuyugrass). For example, the term “turfgrass locus” means the area in which both the broad leaf or grassy weeds and the desired ALS susceptible warm season (C4) turfgrass species have emerged, are growing, or are established such as: golf courses (greens, fairways, tees, and roughs), sports fields, industrial turfgrass, residential turfgrass, amenity grassland or grounds, lawns or turfgrass around airports; cemeteries; commercial establishments and rights of way; houses of worship; military and other institutions; multifamily dwellings; parks; picnic grounds; roadsides; schools; sod farms; and the like. In the context of the present invention, although the turfgrass locus may further comprise other types of plants, weeds or vegetation, the present invention is directed to a method for controlling the unwanted weeds (broadleaf, sedge or grassy weeds) that are present in such locus including emerged, growing as well as established vegetation.

The term “susceptible” means a turfgrass species that is sensitive or can be injured by application of the ALS herbicide (trifloxysulfuron) in the absence of metcamifen. For example, injury, in particular a significant or excessive injury, means unacceptable levels of phytotoxicity, bleaching or stunting of the turfgrass, and/or an unacceptable reduction in turfgrass colour and quality. Turfgrass colour and quality is an industry standard assessment, based on a scale of 1 to 9, with 9 indicating dark green colour of turf and the highest quality. Assessments of turfgrass quality are based on several factors, including stunting, uniformity and density of the turf stand. A turfgrass quality of 6 or less is deemed to be unacceptable.

Accordingly, a method for reducing phytotoxicity to warm season (C4) turfgrass such as St. Augustinegrass or Kikuyugrass due to application of an ALS herbicidal compound such as trifloxysulfuron, or a salt or hydrate thereof alone or in admixture with one or more co-herbicidal compounds comprises applying to the locus of the turfgrass an antidotally-effective amount of metcamifen.

Advantageously, in the practice of the invention a herbicide combination comprising trifloxysulfuron, or a salt or hydrate thereof and a safener, wherein the safener is metcamifen, is applied to selectively control weeds in turfgrass without antagonizing herbicidal efficacy. Preferably, the combination comprises a herbicidally effective amount of trifloxysulfuron, or a salt or hydrate thereof and a safening amount of metcamifen. The turfgrass is an ALS (trifloxysulfuron) susceptible warm season (C4) turfgrass species (such as St. Augustinegrass or Kikuyugrass). The method for selective weed control in such turfgrass is carried out with reduced phytoxicity/herbicidal injury to the otherwise susceptible turfgrass and without reducing or antagonizing the herbicidal activity of the trifloxysulfuron with respect to the unwanted target weeds. The weeds to be controlled are unwanted broadleaf, sedge or grassy weeds or also an unwanted established turfgrass growing at a turfgrass locus (such as perennial ryegrass, bermudagrass, seashore paspalum, creeping bentgrass, tall fescue, and kentucky bluegrass, for example).

In a preferred embodiment of the present invention, the method for selectively controlling unwanted broadleaf, sedge or grassy weeds in the presence of ALS (trifloxysulfuron) susceptible warm season (C4) turfgrass species (such as St. Augustinegrass and Kikuyugrass) at a turfgrass locus comprises applying a broadleaf, sedge or grassy weed controlling amount of an aqueous spray composition to the turfgrass locus, wherein the composition comprises a herbicidally effective amount of trifloxysulfuron, or a salt or hydrate thereof and an effective amount of metcamifen as safener (a safening amount); wherein the trifloxysulfuron is applied to the turfgrass locus at a rate of from 5 to 56 g ai/ha; more specifically at a rate of from 18 to 28 g ai/ha. The metcamifen is applied to the turfgrass locus at a rate 5 to 300 g ai/ha; more specifically at a rate of from 25 to 150 g ai/ha

Suitable weight ratios of the trifloxysulfuron and the metcamifen compound are found, for example, by the above-noted application rates for the individual compounds. In one embodiment, mixing ratios of the trifloxysulfuron (T) and the metcamifen (M) compound according to the invention in the inventive method are, for example: from 5 to 56 g (T) to: 5 to 300 g (M); particularly from 18 to 28 g (T) to 25 to 150 g (M). As noted, other ratios will be apparent to those skilled in the art for any given scenario or based on the above-noted application rates and the herbicide concentrations in suitable commercial formulations used to prepare aqueous spray formulations to be used in the method of the invention. In one embodiment, the weight ratio (w/w) of trifloxysulfuron to metcamifen used in solid or in aqueous spray compositions (including tank mix compositions) that are used in the practice of the methods of the invention is from 1:1 to 1:4; in particular from 1:2 to 1:3.

In accordance with the method of the invention, an aqueous spray composition comprising an herbicidally effective amount of trifloxysulfuron, or a salt or hydrate thereof and an effective amount of metcamifen safener can produce a controlling or modifying effect on the growth of broadleaf, sedge or grassy weeds growing in the presence of ALS (trifloxysulfuron) susceptible warm season (C4) turfgrass species (such as St. Augustinegrass and Kikuyugrass) at a turfgrass locus. Controlling or modifying effects include all deviation from natural development, for example: killing, retardation, leaf burn, albinism, dwarfing, germination prevention and the like. For example, broadleaf, sedge or grassy weeds that are not killed are often stunted and non-competitive with flowering disrupted. The term ‘plants’ refers to all physical parts of a plant, including seeds, seedlings, saplings, roots, tubers, stems, stalks, foliage and fruits.

In one embodiment, an aqueous spray composition is used in the method of the invention which can be prepared on site by the end-user shortly before application to the foliage of the unwanted broadleaf, sedge or grassy weeds growing in the presence of the ALS (trifloxysulfuron) susceptible warm season (C4) turfgrass species to be managed or controlled by mixing water, a trifloxysulfuron containing composition with a composition containing metcamifen and, optionally, a suitable surfactant or adjuvant (such as methylated seed oil, or the like). Such compositions are typically referred to as “tank-mix” compositions. Suitable tank mix compositions can be prepared from mixing commercially available compositions of the active components. Examples of suitable commercial trifloxysulfuron formulations include: Monument®75WG (Syngenta).

Alternatively, the compositions used in the method of the invention may be provided to the end-user already formulated, at the desired dilution for application (“ready to use” compositions) or supplied in a pre-built concentrate format that requires dilution, dispersion, or dissolution in water by the end-user (“concentrate” compositions). The ready-to-use format is particularly suitable for the consumer market. The concentrate formulation may be used in either the consumer market or the professional market, as well. Such preformulated concentrates can be liquids or particulate solids.

In another embodiment, the method of the invention is carried out by application of a dry solid granular herbicidal composition comprising an herbicidally effective amount of the trifloxysulfuron in admixture with an effective amount of a metcamifen safener and an agriculturally acceptable adjuvant or carrier.

The composition useful in the inventive method is generally formulated in various ways using formulation adjuvants, such as carriers, solvents and surface-active substances. Concentrate compositions can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). As noted above, such compositions can either be used directly such as by dry solid granules, or by dilution with water prior to use by tank mix such as by water dispersible granules. The dilutions can be made, for example, with water, liquid fertilisers, micronutrients, biological organisms, oil or solvents.

In one embodiment, a composition of trifloxysulfuron and metcamifen is provided, wherein the weight ratio (w/w) of trifloxysulfuron to metcamifen in the composition is from 1:2 to 1:4; in particular from 1:2 to 1:3. In one embodiment, the composition is a water dispersible granule (WG).

The aqueous spray compositions can be prepared e.g. by mixing the trifloxysulfuron and the metcamifen (“active ingredients”) with the formulation adjuvants in order to obtain compositions in the form of finely divided solids, granules, solutions, dispersions, emulsions microemulsions or suspo-emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the aqueous spray compositions used in the method of the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octa-decanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, aluminium silicate, attapulgite clay, kieselguhr, ammonium chloride-formaldehyde-urea copolymer, polymethyl urea resins, limestone, calcium carbonate, bentonite, calcium montmorillonite, cottonseed husks, wheat flour, soybean flour, pumice, wood flour, ground walnut shells, lignin and similar substances, or mixtures thereof.

A large number of surface-active substances including dispersants and wetting agents can advantageously be used in both solid and liquid formulations, especially in those formulations which can be diluted with a carrier prior to use. Surface-active substances may be anionic, cationic, non-ionic or polymeric and they can be used as emulsifiers, wetting agents, dispersants or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; sodium lignosulfonate, alkylphenol/alkylene oxide addition products, such as nonylphenol ethoxylate; alcohol/alkylene oxide addition products, such as tridecylalcohol ethoxylate; polymers or copolymers such as acrylate copolymers, acrylic/styrene copolymers, methacrylic copolymers, maleic anhydride diisobutylene copolymer sodium salt, furandione, polymer with trimethylpentene, sodium salt and benzenesulfonic acid, dodecyl, sodium salt; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in Mccutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, anti-foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions useful in the method according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10th Edition, Southern Illinois University, 2010.

The compositions useful in the method of the invention generally comprise from 0.1 to 99% by weight, more specifically 10 to 95%, especially from 50 to 75% by weight, of active ingredients and from 1 to 99.9% by weight of a formulation adjuvant which preferably includes from 0 to 25% by weight, preferably 5 to 15% by weight of one or more surface-active substances such as salts of alkylarylsulfonates, alkylnaphthalenesulfonates and/or copolymeric surfactants; and 0 to 25% by weight of a carrier. Whereas commercial products used for tank mix may preferably be formulated as liquid or solid concentrates, the aqueous spray composition applied by the end user will normally employ dilute formulations.

In one embodiment, a suitable composition is a water dispersible granule comprising:
a) 10 to 25 percent by weight of trifloxysulfuron; preferably 18 to 22 percent by weight of trifloxysulfuron;
b) 25 to 65 percent by weight of metcamifen; preferably 30 to 60 percent by weight of metcamifen;
c) 5 to 15% by weight of one or more surface-active substances; preferably 10 to 15 percent by weight of one or more surface-active substances;
d) 0 to 1 percent by weight of an anti-foam; and
e) 5 to 30 percent by weight of one or more inert solid carriers; preferably 5 to 15 percent by weight of one or more inert solid carriers.
   , over the total weight of the herbicide composition.

In one embodiment, the aqueous spray composition used in the method is applied as a post-emergence aqueous spray application accomplished in a customary manner (watering, spraying, atomizing), including a post-emergence aqueous foliar spray application. In the context of the present invention, the term “post-emergence” is taken to mean that the spray composition is applied once the target broadleaf, sedge or grassy weed has emerged from the turfgrass locus that contains an ALS (trifloxysulfuron) susceptible warm season (C4) turfgrass species. In another embodiment, the emerged target broadleaf, sedge or grassy weeds will include growing plants and established plants. The trifloxysulfuron and the metcamifen compound are applied simultaneously or may be applied sequentially to the turfgrass locus (in any order). In this instance the components are typically applied within 3 days and most preferably within 24 hours of each other. Suitably, all the components are administered within a timescale of a few hours, such as one hour. Alternatively, and preferably, the individual components are applied simultaneously by aqueous spray application in a single herbicidal aqueous spray composition to a turfgrass locus. The aqueous spray composition can be prepared by diluting or dispersing a liquid or solid concentrate in water. If the components are sprayed simultaneously, they may be administered separately or as a tank mix or as a pre-formulated mixture of all the components or as a pre-formulated mixture of some of the components which are then tank mixed with the remaining components.

In a preferred embodiment, the method for controlling unwanted broadleaf, sedge or grassy weed at a turfgrass locus comprises applying a broadleaf, sedge or grassy weed controlling amount of an aqueous spray composition to the foliage of the unwanted broadleaf, sedge or grassy weeds that have emerged, are growing, or are established at a turfgrass locus in the presence of a ALS (trifloxysulfuron) susceptible warm season (C4) turfgrass species (preferably, St. Augustinegrass or Kikuyugrass). The method of the present invention also is useful for the spot treatment of broadleaf, sedge or grassy weeds growing at a turfgrass locus, or for clearing all the broadleaf, sedge or grassy weeds from a turfgrass locus.

In one embodiment, with respect to a particular turfgrass locus, the method of the present invention can be carried out with an application program comprising 1 to 3 post sequential spray applications on a 7 to 42-day spray schedule; preferably, on 14-day to 21-day intervals.

If desired, the present invention includes the use of mixtures of more than one herbicide, for example to enhance spectrum of weed control. For example, Mesotrione, sulcotrione, benzobicyclon, tembotrione and topramezone (HPPD herbicide chemistry, Triketone) Others include isoxazoles herbicide chemistry-isoxaflutole and isoxachlortole, and pyrazole herbicide chemistry-benxofenap, pyrazolynate and pyrazoxyfen. Trifloxysulfuron (Sulfonylurea herbicide chemistry) Trifloxysulfuron is only one of a number of herbicides that act as sulfonylurea herbicides. Other sulfonylurea herbicides include metsulfuron, chlorsulfuron, halosulfuron, foramsulfuron, rimsulfuron, sulfosulfuron and flazasulfuron, iodosulfuron, Examples of imidazolinone herbicide chemistry include imaziquin, imazapyr and imazapic. Examples of triazolopyrimide herbicide chemistry include cloransulam-methyl, florasulam, flumetsulam, penoxsulam. Eamples of pyrimidinyl benzoate herbicide chemistry include bispyribac-Na. Examples of sulfonylaminocarbonyl-triazolinone herbicide chemistry include flucarbazone-Na, theincarbazone-methyl. Fluazifop-p-butyl (Aryloxyphenoxy-propionate “FOPS” herbicide chemistry-Fluazifop-p-butyl clodinafop-propargyl, cyhalofop-butyl, diclofop-methyl, fenoxaprop-P-ethyl, haloxyfop-R-methyl, propaquizafop, metamifop and quizalofop-P-ethyl. Examples in Cyclohexanedione “DIMS” herbicide chemistry include alloxydim, butroxydim, clethodim, cycloxydim, profoxydim, sethoxydim, tepraloxydin, tralkoxydim.

It is also possible to use mixtures of more than one safener in conjunction with metcamifen such as cloquintocet, cyprosulfamide and isoxadifen-ethyl, for example, to enhance selectivity (i.e. to provide reduced injury of the herbicidal composition to a broader range of desirable turfgrass species).

In some cases, herbicidal active ingredients have been shown to be more effective in combination with plant growth regulators (PGRs) than when applied individually. Combinations with the following PGR compounds and groups of PGR chemistry are noted: Plant growth regulators include azole PGR Chemistry (such as uniconazole, and paclobutrazol), cyclohexane carboxylates (such as trinexapac-ethyl, and prohexadione-calcium), pyrimidinyl carbinols (such as flurprimidol, and ancymidol), quarternary ammoniums (such as chlormequat-chloride, and mepiquat-chloride), sulphonyl-amino phenyl-acetamides (such as mefluidide), cycloalkenes (such as 1-methylcyclopropene), and hydrochloride salts (such as aminoethoxyvinylglycine). Plant growth regulators such as trinexapac-ethyl are commonly used on turf to improve turf colour, quality, reduce clipping and improved rooting.

The method of the invention may be used against many unwanted grassy, sedge and broadleaf weeds at a turfgrass locus. By way of example, unwanted grassy, sedge and broadleaf weeds to be managed or controlled by the method of the invention include, for example, dicotyledonous weeds such as Allium spp., Alternanthera spp., Aphanes spp., Cerastium spp., Dichondra spp., Diodia spp., Euphorbia sppGeranium spp., Glechoma spp., Gnaphalium spp., Hydrocotyle spp., Hypochaeris spp., Indigofera spp., Kyllinga spp., Lamium spp., Medicago spp., Mollugo spp., Oxalis spp., Ranunculus spp, Soliva spp., Stellaria spp., Taraxacum spp., Trifolium spp., Veronica spp. and Viola spp.

The composition and method of invention may also be sued to control dicots such as English lawn daisy (Bellis perennis) or Mallow (Malva spp.) in St. Augustinegrass and Kikuyugrass at a turfgrass locus.

The invention may also be used to control monocotyledonous weeds such as Bromus spp., Capsella spp., Celosia spp., Digitaria spp., Festuca spp., Hordeum spp., Lolium spp., Panicum spp., Paspalum spp., Poa spp., Poaceae spp., both intrinsically sensitive as well as resistant (e.g. ALS resistant) biotypes of any of these grass weeds, as well as sedges such as Cyperus spp.

More specifically, among the weeds which may be controlled by the composition of the invention, there may be mentioned monocotyledonous weeds such as large and smooth crabgrass (Digitaria sanguinalis, Digitaria ischaemum), Bahiagrass (suppression) (Paspalum spp.), Purple Nutsedge (Cyperus spp.), Broadleaf Signalgrass (Urochloa platyphylla), Torpedograss (suppression) (Panicum repens), Dallisgrass (suppression) (Paspalum dilatatum), Annual sedge (Cyperus compressu), Globe Sedge (Cyperus globulosus), Annual bluegrass (Poa annua), Rescuegrass (Bromus catharticus), Cock's-Comb (Celosia argentea), Ryegrass (Lolium perenne), Shephard's-purse (Capsella bursa-pastoris), Tall Fescue (Festuca arundinacea), Little Barley (Hordeum pusillum), yellow nutsedge (Cyperus esculentus), and dicotyledonous weeds such as dandelion (Taraxacum spp.; Taraxacum officinale), hop, white and red clover (Trifolium spp.), chickweed (Stellaria media), henbit (Lamium amplexicaule), corn speedwell (Veronica arvensis), oxalis (Oxalis spp.; Oxalis acetosella), dollar weed (Hydrocotyle umbellata), wild violets (Viola spp.), black medic (Medicago lupulina), buttercup (Ranunculus sardous), carpetweed (Mollugo verticillata), ground ivy (Glechoma hederacea), virginia buttonweed (seedlings) (Diodia virginiana), field pansy (Viola arvensis), narrowleaf cudweed (Gnaphalium falcatum), car's ear dandelion (Hypochaeris radicata), green kyllinga (Kyllinga brevifolia), parsley piert (Aphanes arvensis), carolina geranium (Geranium carolinianum), rabbitsfoot clover (Trifolium arvense), kyllinga (Kyllinga spp.), khakiweed (Alternanthera pungens), lawn burweed (Soliva sessilis), Spotted Spurge (Euphorbia maculata), creeping indigo (Indigofera spicata), Lawn pennywort (Hydrocotyle sibthorpioides), wild garlic (Allium ursinum), dichondra (Dichondra spp.), mouseear chickweed (Cerastium fontanum).

In some embodiments, an unwanted established turfgrass growing at a turfgrass locus such as perennial ryegrass, bermudagrass, seashore paspalum, creeping bentgrass, tall fescue, and kentucky bluegrass can be removed from a turfgrass locus in the context of the invention. Accordingly, the present invention also provides a method of selectively controlling an unwanted established turfgrass in the presence of a desired turfgrass selected from St. Augustinegrass and Kikuyugrass at a turfgrass locus, comprising applying to the turfgrass locus a composition comprising a herbicidally effective amount of trifloxysulfuron, or a salt or hydrate thereof and a safening amount of metcamifen.

In one embodiment, the susceptible/sensitive warm season (C4) turfgrass species at a turfgrass locus include, but are not limited to, Bermudagrasses (Cynodon L. C. Rich), Zoysiagrasses (Zoysia Willd.), St. Augustinegrass (Stenotaphrum secundatum (Walt.) Kuntze), Kikuyugrass. (P. clandestinum), Buffalograss (Buchloe dactyloides (Nutt.) Engelm.). In one embodiment, the warm season (C4) turfgrass species is ALS (trifloxysulfuron) susceptible. In one embodiment, preference is given to St. Augustinegrass and Kikuyugrass.

In an alternative embodiment of the present invention, unwanted established turfgrass selected from bermudagrass, seashore paspalum, creeping bentgrass, tall fescue, and kentucky bluegrass (preferably bermudagrass) at a turfgrass locus can be converted to a turf selected from zoysiagrass, St. Augustinegrass, and Kikuyugrass (preferably zoysiagrass) more quickly and economically as compared to traditional methods by using oversprigging with herbicide mixtures including metcamifen with trifloxysulfuron, an ACCase and, optionally, a pyridine herbicide. (In traditional methods, zoysiagrass can be established from sprigs but requires a lengthy herbicide program with non-selective herbicides such as glyphosate to eradicate the existing turfgrass before the sprigs are planted).

In accordance with the alternative embodiment, established turfgrass areas selected from bermudagrass, seashore paspalum, creeping bentgrass, tall fescue, and kentucky bluegrass (preferably bermudagrass) can be converted to a turfgrass selected from zoysiagrass, St. Augustinegrass, and Kikuyugrass (preferably zoysiagrass) by oversprigging with herbicide mixtures including metcamifen with trifloxysulfuron, an ACCase or a pyridine herbicide; i.e. without the need to eradicate the established turfgrass with glyphosate or other such herbicides. This alternative method also contemplates oversprigging with herbicide mixtures including metcamifen with an ACCase or a pyridine herbicide.

In one embodiment of this oversprigging method, sprigs (cuttings containing one or more nodes) of a turfgrass selected from zoysiagrass, St. Augustinegrass, and Kikuyugrass (preferably zoysiagrass) are spread at 100 to 200 cubic meters per hectare (1200 to 2000 bushels per acre) directly on top of the existing/established turfgrass (selected from bermudagrass, seashore paspalum, creeping bentgrass, tall fescue, and kentucky bluegrass (preferably bermudagrass)) growing at a turfgrass locus. The sprigs are then crimped to ensure sprig-soil contact and topdressed with sand or soil to retain moisture.

Subsequently, a herbicidally effective amount of a herbicide selected from an ACCase herbicide and a pyridine herbicide and an effective amount of metcamifen as safener is applied to the turfgrass locus. Optionally, trifloxysulfuron can be applied together with the metcamifen in the weight ratios described herein) along with an ACCase and/or pyridine herbicide to the existing oversprigged turfgrass; in one embodiment, such herbicide/metcamifen application is made. approximately 1 week after oversprigging, i.e. where the sprigs of a turfgrass selected from zoysiagrass, St. Augustinegrass, and Kikuyugrass (preferably zoysiagrass) are spread on top of the existing turfgrass (selected from bermudagrass, seashore paspalum, creeping bentgrass, tall fescue, and kentucky bluegrass (preferably bermudagrass)).

In the practice of the oversprigging embodiment, metcamifen can be applied from 5 to 300 g ai/ha more specifically 25 to 150 g ai/ha (with or without trifloxysulfuron in the weight ratios and rates described herein). The ACCase herbicide, for example, fluazifop-p-butylcan be applied at 70 to 560 g ai/ha more specifically at 105 to 560 g ai/ha. When present, the pyridine herbicide, for example, triclopyr can be applied at 280 to 2240 g ai/ha.

In one embodiment, 1 to 3 post sequential foliar applications of the trifloxysulfuron, or a salt or hydrate thereof and the metcamifen are made to the turf locus on a 7 to 42-day spray schedule or interval:
preferably, on 14-day to 21-day intervals.
a composition comprising a herbicidally effective amount of trifloxysulfuron, or a salt or hydrate thereof and a safening amount of metcamifen

In one embodiment, an established turf area with ‘Tifway’ bermudagrass, is oversprigged with ‘Zorro’ zoysiagrass at 1600 to 2000 bushels per acre followed by 2 applications of a composition comprising trifloxysulfuron, metcamifen and fluazifop-p-butyl (and optionally triclopyr) at the above referenced rates on a 5-week interval resulted in 95% zoysiagrass coverage at 10 weeks after sprigging, (A US bushel is ca 35.3 liters or 0.0353 cubic meters.)

Various aspects and embodiments of the present invention will now be illustrated in more detail by way of example. It will be appreciated that modification of detail may be made without departing from the scope of the invention.

### EXAMPLES

### Example 1

In a trial conducted on St Augustinegrass variety ‘Classic’, trifloxysulfuron (TSS) (Monument 75 WDG) was applied at 28 g ai/ha with and without metcamifen applied at 30, 75 and 150 g ai/ha. Two applications were applied on a 30-day interval (initial treatment and second treatment). Trifloxysulfuron solo resulted in significant injury (80 to 90%). Metcamifen provided almost complete trifloxysulfuron safening. Less than 5% injury was observed at all rating dates.

| | 9 DAIT* | | | | | | 30 DAIT | | | | | |
|---|---|---|---|---|---|---|---|---|---|---|---|---|
| | Initial | | | | | | Second | | | | | |
| Treatment | Treatment | | 17 DAIT | | 24 DAIT | | Treatment | | 41 DAIT | | 51 DAIT | |
| Non-treated Control | 0 | f** | 0 | c | 0 | c | 0 | f | 0 | d | 0 | c |
| TSS (Monument) 28 g | 71 | a | 85 | a | 98 | a | 85 | a | 80 | a | 81 | a |
| TSS 28 g + Metcamifen 30 g | 18 | c | 3 | c | 0 | c | 8 | de | 9 | c | 0 | c |
| TSS 28 g + Metcamifen 75 g | 5 | ef | 0 | c | 0 | c | 6 | def | 6 | cd | 0 | c |
| TSS 28 g + Metcamifen 150 g | 5 | ef | 0 | c | 0 | c | 9 | de | 13 | c | 0 | c |

*DAIT—Days after the initial application
**LSD P = 0.05

### Example 2

In a kikuyugrass trial, trifloxysulfuron (TSS) (Monument 75 WDG) was applied solo at 28 g ai/ha and compared to a mixture of TSS and metcamifen (MET). The TSS-MET mixture contains trifloxysulfuron and meticamifen at a ratio of 20 to 75 g. Both Monument and the TSS-MET mixture were applied at 28 g ai/ha TSS. Two applications were applied on a 28-day interval Trifloxysulfuron solo resulted in significant injury (40%). Metcamifen provided almost complete trifloxysulfuron safening. Less than 10% % injury was observed at all rating dates.

| Treatment | gai/ha | 14DAA-1 | 21 DAA-1 | 28 DAA-1 | 7DAA-2 | 14 DAA-2 | 21 DAA-2 | 28 DAA-2 |
|---|---|---|---|---|---|---|---|---|
| Check | 28 | 0c | 0c | 0b | 0d | 0d | 0c | 0c |
| TSS | 28 | 22.5a | 37.4a | 34.9a | 40a | 40a | 40a | 32.5a |
| TSS + Met | 28 | 5bc | 2.6bc | 0b | 7.5c | 7.5c | 1.3c | 2.5c |

*DAA-1—Days after application 1; DAA-2—Days after application 2
** Tukey's HSD P = 0.05

These data demonstrate how effective and novel the trifloxysulfuron safening is with metcamifen on susceptible/sensitive warm season (C4) turfgrass species, especially St Augustine and kikuyugrass.

1. A method of selectively controlling weeds in ALS herbicide susceptible turfgrass, comprising applying to the ALS herbicide susceptible turfgrass a herbicidally effective amount of trifloxysulfuron, or a salt or hydrate thereof and a safening amount of metcamifen.

2. The method according to claim 1, which comprises selectively controlling unwanted weeds in the presence of an ALS herbicide susceptible warm season (C4) turfgrass at a turfgrass locus, comprising applying to the turfgrass locus a herbicidally effective amount of trifloxysulfuron, or a salt or hydrate thereof and a safening amount of metcamifen.

3. The method according to claim 1, which comprises selectively controlling unwanted weeds in the presence of a warm season grass selected from St. Augustinegrass and Kikuyugrass at a turfgrass locus without antagonizing herbicidal efficacy, comprising applying to the turfgrass locus a composition comprising a herbicidally effective amount of trifloxysulfuron, or a salt or hydrate thereof and a safening amount of metcamifen.

4. The method according to claim 1, wherein trifloxysulfuron is applied to the turfgrass locus at a rate of from 5 to 56 g ai/ha; more specifically at a rate of from 18 to 28 g ai/ha.

5. The method according to claim 1, wherein metcamifen is applied to the turfgrass locus as (2-Methoxy-N-[[4-[[(methylamino)carbonyl]amino]phenyl]sulfonyl]benzamide).

6. The method according to claim 1, wherein metcamifen is applied or formulated as a crystalline polymorph selected from the group consisting of the polymorph designated Form 1, the polymorph designated Form 2 and the polymorph designated Form 3.

7. The method according to claim 1, wherein metcamifen is applied to the turfgrass locus at a rate of from 5 to 300 g ai/ha.

8. The method according to claim 1, wherein trifloxysulfuron and metcamifen are applied to the turfgrass locus simultaneously.

9. The method according to claim 1, wherein trifloxysulfuron and metcamifen are applied to the turfgrass locus by a post-emergence foliar treatment.

10. The method according to claim 1, wherein trifloxysulfuron and metcamifen are applied to the turfgrass locus in an aqueous spray composition.

11. The method according to claim 1, wherein the aqueous spray volume applied to the turf locus is from 100 to 300 l/ha.

12. The method according to claim 1, wherein trifloxysulfuron and metcamifen are applied to the turfgrass locus in 1 to 3 post sequential foliar applications on a 7 to 42-day spray schedule.

13. The method according to claim 1, wherein the susceptible turfgrass is warm season (C4) turfgrass species selected from Bermudagrasses (Cynodon L. C. rich), Zoysiagrasses (Zoysia willd.), St. Augustinegrass (Stenotaphrum secundatum (Walt.) Kuntze), Centipedegrass (Eremochloa ophiuroides (Munro.) Hack.), Buffalograss (Buchloe dactyloides (Nutt.) Engelm.), Seashore paspalum (Paspalum vaginatum);

14. The method according to claim 13, wherein the susceptible turfgrass is selected from St. Augustinegrass and Kikuyugrass.

15. The method according to claim 1, wherein the unwanted weed is selected from dicotyledonous weeds such as Allium spp., Alternanthera spp., Aphanes spp., Cerastium spp., Dichondra spp., Diodia spp., Euphorbia sppGeranium spp., Glechoma spp., Gnaphalium spp., Hydrocotyle spp., Hypochaeris spp., Indigofera spp., Kyllinga spp., Lamium spp., Medicago spp., Mollugo spp., Oxalis spp., Ranunculus spp, Soliva spp., Stellaria spp., Taraxacum spp., Trifolium spp., Veronica spp. and Viola spp., monocotyledonous weeds such as Bromus spp., Capsella spp., Celosia spp., Digitaria spp., Festuca spp., Hordeum spp., Lolium spp., Panicum spp., Paspalum spp., Poa spp., Poaceae spp., both intrinsically sensitive as well as resistant (e.g. ALS resistant) biotypes of any of these grass weeds, as well as sedges such as Cyperus spp., monocotyledonous weeds such as large and smooth crabgrass (Digitaria sanguinalis, Digitaria ischaemum), Bahiagrass (suppression) (Paspalum spp.), Purple Nutsedge (Cyperus spp.), Broadleaf Signalgrass (Urochloa platyphylla), Torpedograss (suppression) (Panicum repens), Dallisgrass (suppression) (Paspalum dilatatum), Annual sedge (Cyperus compressu), Globe Sedge (Cyperus globulosus), Annual bluegrass (Poa annua), Rescuegrass (Bromus catharticus), Cock's-Comb (Celosia argentea), Ryegrass (Lolium perenne), Shephard's-purse (Capsella bursa-pastoris), Tall Fescue (Festuca arundinacea), Little Barley (Hordeum pusillum), yellow nutsedge (Cyperus esculentus), and dicotyledonous weeds such as dandelion (Taraxacum spp.; Taraxacum officinale), hop, white and red clover (Trifolium spp.), chickweed (Stellaria media), henbit (Lamium amplexicaule), corn speedwell (Veronica arvensis), oxalis (Oxalis spp.; Oxalis acetosella), dollar weed (Hydrocotyle umbellata), wild violets (Viola spp.), black medic (Medicago lupulina), buttercup (Ranunculus sardous), carpetweed (Mollugo verticillata), ground ivy (Glechoma hederacea), virginia buttonweed (seedlings) (Diodia virginiana), field pansy (Viola arvensis), narrowleaf cudweed (Gnaphalium falcatum), car's ear dandelion (Hypochaeris radicata), green kyllinga (Kyllinga brevifolia), parsley piert (Aphanes arvensis), carolina geranium (Geranium carolinianum), rabbitsfoot clover (Trifolium arvense), kyllinga (Kyllinga spp.), khakiweed (Alternanthera pungens), lawn burweed (Soliva sessilis), Spotted Spurge (Euphorbia maculata), creeping indigo (Indigofera spicata), Lawn pennywort (Hydrocotyle sibthorpioides), wild garlic (Allium ursinum), dichondra (Dichondra spp.), and mouseear chickweed (Cerastium fontanum).

16. A method for conversion of an established turfgrass selected from bermudagrass, seashore paspalum, creeping bentgrass, tall fescue, and kentucky bluegrass at a turfgrass locus comprising:
spreading sprigs of a turfgrass selected from zoysiagrass, St. augustinegrass, and kikuyugrass at 100 to 200 cubic meters per hectare on top of established turfgrass at the turfgrass locus; and
applying a herbicidally effective amount of an herbicide selected from an ACCase herbicide, a pyridine herbicide and, optionally, trifloxysulfuron; and an effective amount of metcamifen as safener to the turfgrass locus.

17. The method according to claim 1, wherein a water dispersible granule composition comprising trifloxysulfuron and metcamifen in a weight ratio (w/w) of trifloxysulfuron to metcamifen of from 1:2 to 1:4 is used.

18. A safened herbicidal composition for use in turfgrass susceptible to injury by an ALS herbicide comprising: a) a herbicidally effective amount of trifloxysulfuron, or a salt or hydrate thereof; and b) a safening amount of metcamifen, wherein the safened herbicidal composition is capable of safening the trifloxysulfuron, or a salt or hydrate thereof, to the turfgrass.

19. A composition according to claim 18 comprising a water dispersible granule composition.

20. A method for reducing phytotoxicity to warm season (C4) turfgrass selected from St. Augustinegrass and Kikuyugrass due to application of an ALS herbicidal compound such as trifloxysulfuron, or a salt or hydrate thereof alone or in admixture with one or more co-herbicidal compounds comprises applying to the locus of the turfgrass an antidotally-effective amount of metcamifen.
